(19) United States
(12) Patent Application Publication
(10) Pub. No.: US 2014/0032262 A1
(43) Pub. Date: Jan. 30, 2014

(54) LEAD GENERATION AND MARKETING NETWORK

(71) Applicant: GainClients, Inc., Tucson, AZ (US)

(72) Inventor: Raymond Desmond, Tucson, AZ (US)

(21) Appl. No.: 13/934,552

(22) Filed: Jul. 3, 2013

Related U.S. Application Data
(60) Provisional application No. 61/677,339, filed on Jul. 30, 2012.

(51) Int. Cl. G06Q 30/02; G06Q 50/16

(52) U.S. Cl. CPC G06Q 30/0201; G06Q 50/16
USPC 705/7.29

(57) ABSTRACT

A network is presented that includes a server having a processor, a non-transitory computer readable medium in communication with the processor, and computer readable program code encoded in the computer readable medium. Encoded in the computer readable medium are multiple professional member profiles and multiple nonprofessional users, where each of the professional member profiles is associated with a professional member of the network and each of the nonprofessional user profiles is associated with a nonprofessional user of the network and is assigned to a professional member, and an activity database having multiple records each corresponding to activity of one of the nonprofessional users on the network. The computer readable program code comprises computer readable program steps that, when executed by the processor, generate a lead based on one of the plurality of records.

### RELATED APPLICATIONS

The application claims priority to, and the benefit of, U.S. Provisional Patent Application Ser. No. 61/677,339, filed on Jul. 30, 2012, titled “Lead Generation and Marketing Network,” the entire contents of which are incorporated herein by reference.

### FIELD OF REFERENCE

The present application relates to marketing networks and, more particularly, to real estate lead generation and marketing networks.

### BACKGROUND

Currently the process undergone by a buyer to search real estate listings, secure a loan, obtain title services is not coordinated. Furthermore, there is no manner for real estate agents, loan officers, and title agents to monitor the activity of potential buyers and use the same to become valued partners in the search for a new home. For example, listings of available real estate are stored in a computer system, referred to as a “multiple listing services” or “MLS.” To access these listings a potential buyer may perform an internet search using a computer. However, each listing returned by the search engine may reference a different listing agent. If the potential buyer wants to view, for example, three different properties, the buyer may contact three different agents to set up appointments. When the buyer wants to seek preapproval for a loan they may again do an internet search to find the name of several loan officers. Often the loan offers have no relationship with any of the real estate agents associated with the properties the buyer is interested in. Further, a real estate agent, for example, is unable to monitor the buyer's activity so that the agent can contact the same to offer to show a house that the buyer has viewed multiple times, provide suggestions based on the buyer's search criteria, or introduce the buyer to a loan officer or title agent the real estate agent has a professional relationship with.

### SUMMARY OF THE INVENTION

In one implementation, a network is presented that includes a server having a processor, a non-transitory computer readable medium in communication with the processor, and computer readable program code encoded in the computer readable medium. Encoded in the computer readable medium are multiple professional member profiles and multiple nonprofessional user, where each of the professional member profiles is associated with a professional member of the network and each of the nonprofessional user profiles is associated with a nonprofessional user of the network and is assigned to a professional member, and an activity database having multiple records each corresponding to activity of one of the nonprofessional users on the network. The computer readable program code comprises computer readable program steps that, when executed by the processor, generate a lead based on one of the plurality of records.

In another implementation a computer program product is presented. The computer program product is encoded in a computer readable medium and useable with a programmable computer processor to generate a lead for one of multiple professional members of a network, where the network is used by multiple nonprofessional users, where each of the nonprofessional users are assigned to one of the professional members. The computer program product includes computer readable program code which causes said programmable processor to generate a lead based on activity of one of the nonprofessional users on the network, and to notify the professional member assigned to the one of the plurality of nonprofessional users whose activity the lead is based on.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block diagram depicting an exemplary embodiment of Applicant's network;

FIG. 2 is a diagram of an exemplary internet-enabled device for use in accessing Applicant's network;

FIG. 3A is a block diagram of an exemplary embodiment of Applicant's professional network environment;

FIG. 3B is a block diagram of an exemplary embodiment of Applicant's enterprise network environment;

FIG. 4 is a block diagram of an exemplary embodiment of Applicant's buyer network environment;

FIG. 5 is an exemplary flowchart of a method for assigning a new buyer a professional team;

FIG. 6 is an exemplary flowchart of a method for generating leads based on a buyer's activity on Applicant's network; and

FIG. 7 is an exemplary flowchart of a method for generating leads based on the receipt of a text message requesting information on a property listing.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules (e.g., modules 302-320 and 402-420) in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Applicant's invention includes a real estate marketing network which allows professional users to invite potential buyers and other professionals to be a part of their network, share leads, and provide buyers with real estate, lending, and title services and information. By “professionals” Applicant refers to real estate agents (or realtors), title agents, and loan officers. By “buyers” Applicant refers to individual consumers who have bought or may potentially buy real estate. Applicant's invention connects teams of professionals with buyers in a coordinated manner to facilitate the purchase of real estate.

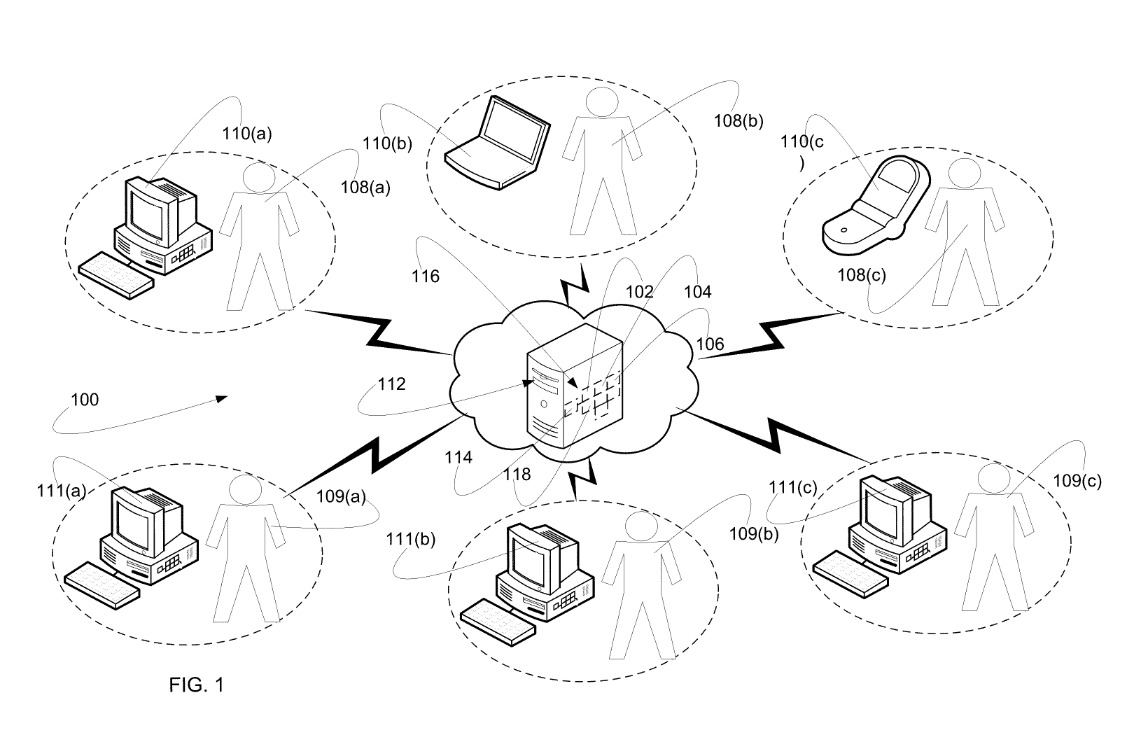

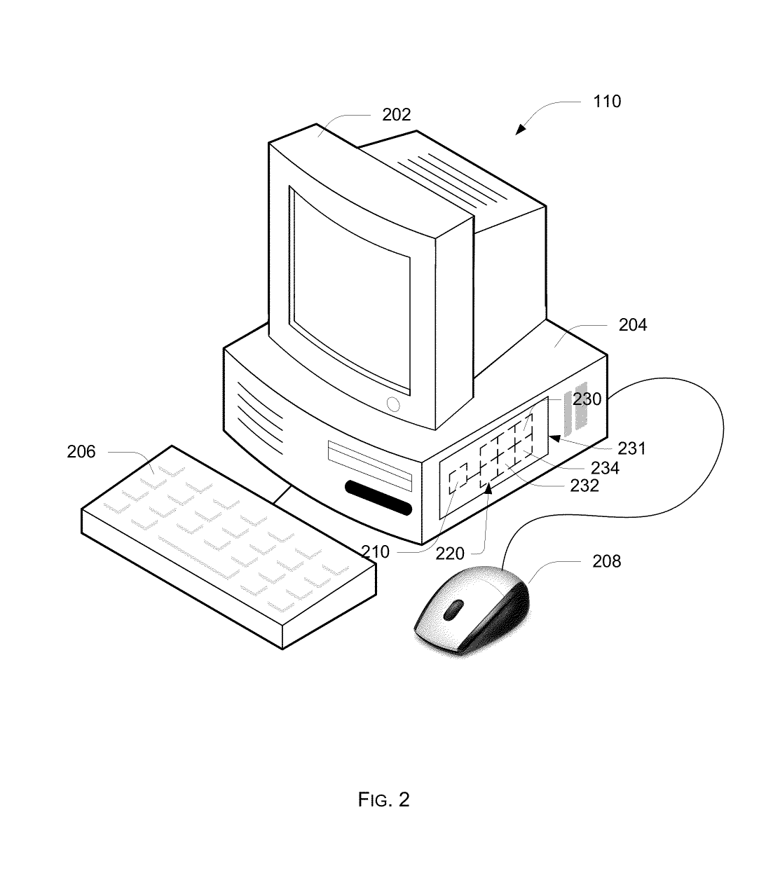

Turning now to FIG. 1, a block diagram is presented depicting an exemplary embodiment of Applicant's marketing network. In the illustrated embodiment of FIG. 1, a buyer, such as buyer 108(a) (or 108(b) or 108(c)), of Applicant's network 100 uses an internet-enabled device, such as apparatus 110(a), to access network 100. Apparatus 110(a) (or 110(b) or 110(c)) may be any device capable of accessing a webpage, such as, and without limitation, a personal computer, laptop, tablet PC, cellular telephone, personal digital assistant (PDA), SmartPhone or similar device. An exemplary embodiment of apparatus 110(a) is depicted in FIG. 2.

As can be seen in FIG. 2, apparatus 110 comprises computing device 204, a visual display device 202 and a data input device, such as for example and without limitation, a keyboard 206 and/or a mouse 208. In certain embodiments, visual display device 202 may be the same as the data input device, such as is seen with smart phones and tablets wherein the display screen is touch-sensitive. Computing device 204 comprises controller 231 comprising a programmable processor 210 interconnected via communication links with non-transitory computer readable medium 220, computer readable program code 230 encoded in the non-transitory computer readable medium 220, optional VoIP module 232, and optional “WI-FI” module 234. In certain embodiments, computing device 204, visual display device 202, and data input device are combined into a single hand-held device, such as a tablet PC, laptop computer, cellular telephone, or PDA.

In certain embodiments, visual display device 202 comprises a liquid crystal display (LCD) display, or a plasma display. In other embodiments, visual display device 202 comprises a video projector and screen.

In certain embodiments, non-transitory computer readable medium 220 comprises non-volatile memory. In certain embodiments, non-transitory computer readable medium 220 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like.

Optional VoIP module 232 implements a Voice over Internet Protocol (VoIP). VoIP is a general term for a family of transmission technologies for delivery of voice communications over IP networks such as the Internet or other packet-switched networks. Internet telephony includes communications services, such as and without limitation voice, facsimile, and/or voice-messaging applications that are transported via the Internet, rather than the public switched telephone network (PSTN).

Optional WI-FI module 234 comprises a wireless network communication module comprising a wireless network permitting communication with one or more external computers or programmable devices in a network or with point-to-point communications. In certain embodiments, WI-FI module 234 implements one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example apparatus 110(a) (FIG. 1), and a server, or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or WI-FI, which comprises an extension to 802.11 that applies to wireless LANS and provides up to about 11 Mbps transmission in the 2.4 GHz band; and/or (iv) specification 802.11g which applies to wireless LANs and provides 20+Mbps in the 2.4 GHz band.

Processor 210 uses computer readable program code 230 to operate controller 231, WI-FI module 234, VoIP module 232, and visual display device 202.

While the foregoing description of FIG. 2 has been provided regarding the internet-enabled devices used by buyers to access Applicant's network 100, one of ordinary skill in the art will appreciate that the description is equally applicable to the internet-enabled devices 111(a)-111(c) used by professionals 109(a)-109(c) to access network 100. Furthermore, while internet-enabled device 110 is depicted in FIG. 2 as being a personal computer, one of ordinary skill in the art will appreciate that the description provided is equally applicable to other types of internet-enabled devices such as laptops, smart phones, tablets, PDAs, and the like.

Returning to FIG. 1, buyer 108(a) uses internet-enabled apparatus 110(a) to access Applicant's network 100 to gain information on real estate listings and to connect with professionals 109(a)-109(c). Data may be transmitted to and from Applicant's network 100, buyer 108(a)'s internet-enabled apparatus 110(a), and professionals 109(a)-109(c)'s internet-enabled apparatus 111(a)-111(c) using optional Wi-Fi module 234, optional VoIP module 232, or any computer network capable of connecting to the internet such as a local-area network (LAN) or wide-area network (WAN).

Applicant's network 100 comprises server 112 comprising a programmable processor 114 interconnected via a communication link with non-transitory computer readable medium 116, and computer readable program code 118 encoded in non-transitory computer readable medium 116. One of ordinary skill in the art will appreciate that while FIG. 1 depicts a single server, in certain embodiments Applicant's network may comprise multiple servers without departing from the scope of the present invention.

In certain embodiments, non-transitory computer readable medium 116 comprises non-volatile memory. In certain embodiments, non-transitory computer readable medium 116 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like. In certain embodiments non-transitory computer readable medium 116 is segregated into logical volumes for each member of network 100.

In the illustrated embodiment of FIG. 1, server 112 further comprises listing database 102, member database 104, and activity database 106. In such embodiments, listing database 102 includes each property listing available through Applicant's network 100. In certain embodiments, listing database 102 further includes the realtor listing the property and whether that realtor is a member of network 100. Member database 104 includes the personal information of each member of network 100 including one or more of their name, telephone number, email, address, user type (either buyer, realtor, loan officer, or title agent), and pre-approval amount (if a buyer). Activity database 106 maintains a record of each buyer's activity on network 100. In certain embodiments this record comprises one or more of the property listings viewed, the properties added to a buyer's favorites list, the properties a buyer has forwarded or looked at multiple times, and/or the search criteria the buyer is using. As will be discussed further, this information is used to generate leads and score cards for professional members.

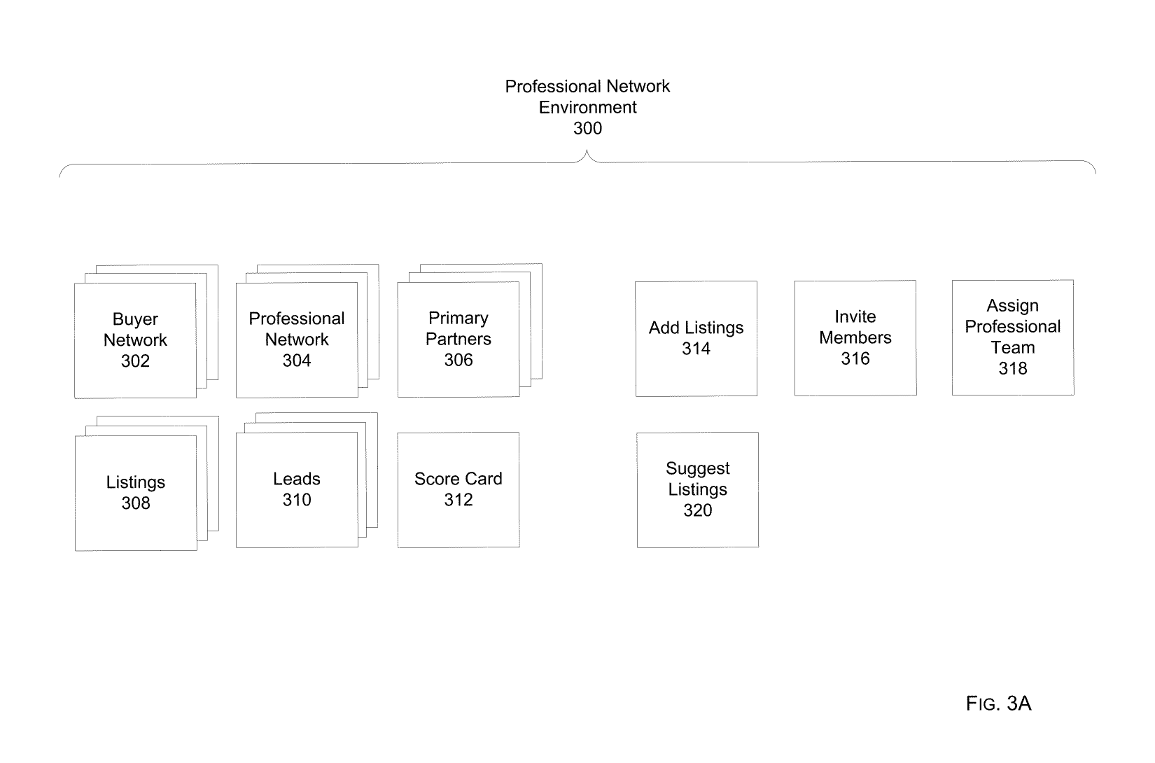

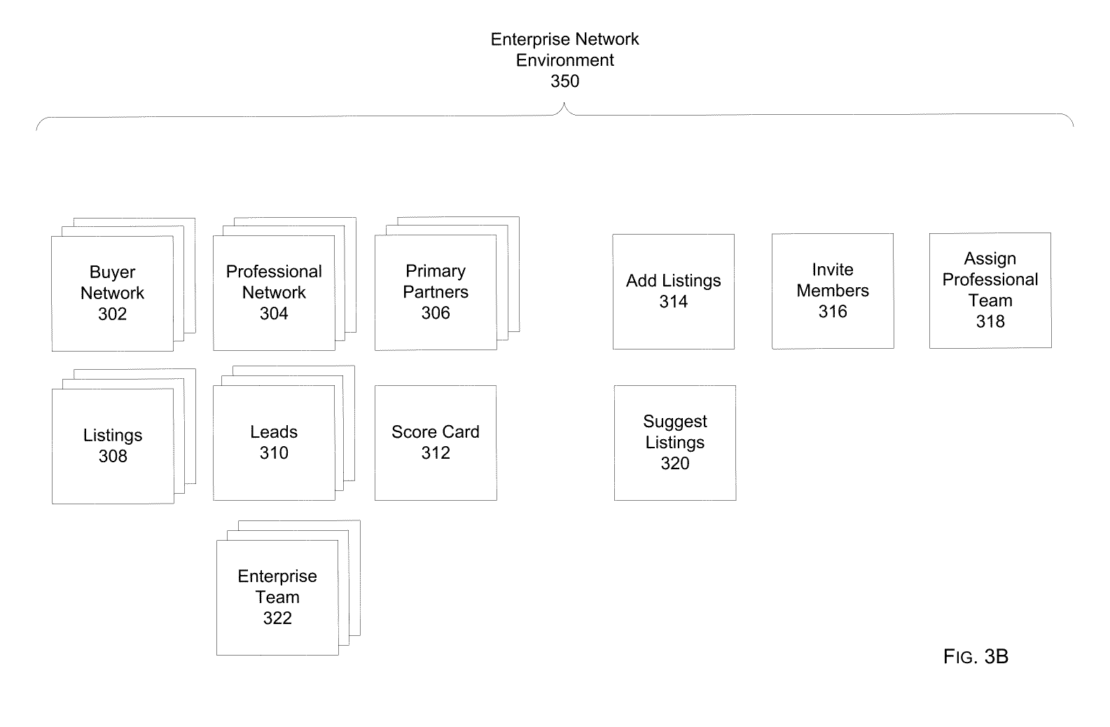

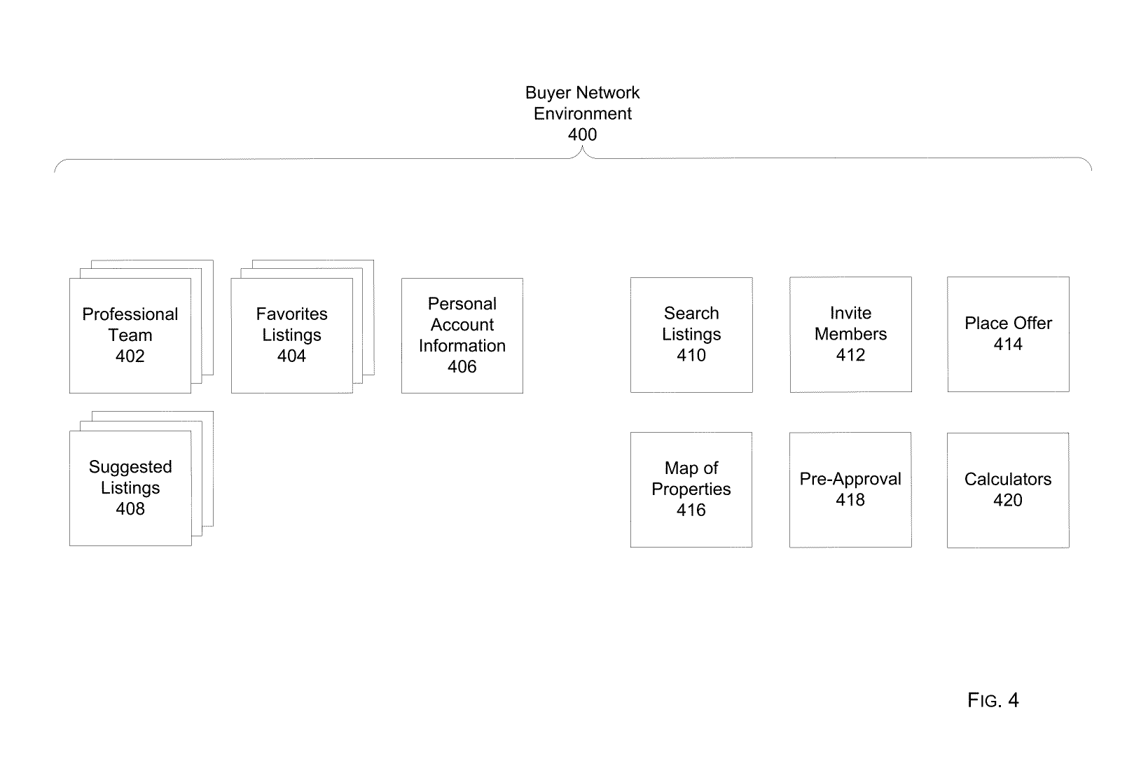

Within network 100, two separate network environments are provided: professional network environment 300 (FIG. 3A), and buyer network 400 (FIG. 4). When a user accesses network 100, network 100 implements source code to present a graphical user interface to the user displaying either network environment depending on the user's status within the network. As can be seen in FIG. 3A, the professional network environment 300 is provided to each professional member and comprises a buyer network module 302, professional network module 304, primary partners module 306, listings module 308, leads module 310, and score card module 312. In certain embodiments professional network environment 300 also comprises one or more of an add listings module 314, an invite members module 316, an assign professional team module 318, and a suggest listings module 320.

While the following description of professional network environment 300 and buyer network 400 is generally provided in terms of a single professional or buyer as the member associated with each account on Applicant's network, one of ordinary skill in the art will appreciate that the description is broad enough to include teaming among professionals or buyers. More specifically, by teaming, multiple users can be associated under one account on network 100, allowing each one to view and have access to the same network environment and information. For example, a team of mortgage professionals from the same mortgage firm may want to be associated with a single account, thereby receiving the same information and sharing in responding to buyers, leads, and other activities. One embodiment of a formalized professional team using a single account is discussed in the context of the enterprise network environment 350 (FIG. 3B). For consumers, when multiple buyers are associated with a single account, each individual can separately request information on different properties using different cell phones or computers and when they accesses the team network environment they will be presented with not only the properties they requested information on but also those their team members did. Additionally, the recommendations provided to the buyer team will be based on the activity of all the team members rather than any individual.

For each professional member (or team of professional members), buyer network module 302 includes each of the buyers invited into the network by that professional member. In certain embodiments, buyer network module 302 further includes buyers who, instead of being invited by the professional member themselves, were invited by one of the other buyers in that professional member's network. When a buyer is part of a professional member's network, that buyer is said to be “owned” by the professional member and will be automatically connected to that professional each time they use the network. Thus, for example and without limitation, each time a buyer uses the network, the network will display the contact information and, in some embodiments, a photograph of the professional member who invited them as part of the page the buyer is currently viewing. In certain embodiments, each buyer's activity on the network is also recorded and all or part of that activity is reported to or used to generate a lead for the professional member owning the buyer.

Similar to the buyer network module 302, for each professional member the professional network module 304 comprises other professionals (i.e., realtors, title agents, and loan officers) that the member has invited to be in their professional network. Generally a professional member will only invite other professionals to be a part of their network who provide a different service from themselves. For example and without limitation, a realtor would only invite title agents and loan officers to be a part of their network. However, in certain embodiments, a professional member may also invite other professional members who provide similar services to them. This may occur, by way of example and not limitation, when the professional member is a realtor who represents only buyers. Such a professional member may have other realtors in their network who represent sellers so that each can share leads.

Primary partners module 306 includes those members listed in professional network module 304 that the professional member has designated as their primary partners. As will be explained further, primary partners trump all other individuals listed in that member's professional network and will automatically be assigned, along with that member, to each buyer in that member's buyer network. In the typical embodiment, a professional member will have only two other members listed as primary partners, each providing different services from them. Thus, by way of example and not limitation, a realtor will have one title agent and one loan officer as primary partners while a title agent will have one loan officer and one realtor as primary partners. In other embodiments, a professional member may have only one or even no primary partners where they haven't designated any individuals. Thus, for example and without limitation, a title agent may designate a specific realtor to be their primary partner but may not have designated any loan officers. In other embodiments, a professional member may have more than two individuals as part of their primary network.

For each professional member, listings module 308 includes those property listings the professional member is associated with. In certain embodiments this includes property where the professional member or another individual in their professional network is the listing agent. In some such embodiments, the listing module 308 for title agents and loan officers contains only those listings associated with realtors in each title agent's or loan officer's professional network. Further, in certain such embodiments, a property listing may be added to a title agent or loan officer's listing module only where the realtor has designated that member as part of their primary team. In other embodiments, listing module 308 includes property listings that the member is not the listing agent of Generally, property listings are added to a professional member's listing module automatically by network 100, which obtains the same from the Multiple Listing Service (“MLS”). However, in certain embodiments a professional member can manually add listings to their listing module 308 using add listing module 314. Furthermore, listings may also appear in a member's listing module 308 by virtue of the listing being associated with an individual in that member's professional network.

Leads module 310 contains each professional member's leads that are generated by Applicant's network 100. As used herein a “lead” is a notice sent to a professional member which indicates a buyer may be interested in a particular listing, thereby allowing the professional member to follow-up with the buyer in a timely manner and introduce themselves, schedule walk-throughs of the property, or offer other services. In certain embodiments, a lead is generated when a buyer, who is not owned by any professional member (i.e., an unregistered buyer) views or requests information on a property listed by the professional member. In certain other embodiments, a lead is generated when a buyer within that professional member's buyer network takes an action on network 100 that meets a threshold for generating a lead. By way of example and not limitation, leads may be generated when a buyer in the professional member's network requests information on a property listing via text message, adds a property listing to their favorites list, views the property listing more than once, forwards the property listing, or views the property listing for a given length of time.

In certain embodiments, each lead includes information on the property, such as the address, MLS number, and/or price, and a means for contacting the buyer who triggered the lead, such as and without limitation, a telephone number or email. In certain embodiments a lead also includes the buyer's name. In certain embodiments a lead further includes profile information about the buyer. In such embodiments, profile information may include the amount the buyer has been pre-approved for, the price range of other property listings viewed, the mean or median value of the property listings viewed, the geographic area of other properties the buyer has viewed, or attributes of the property listings viewed, such as square footage, number of bedrooms, number of bathrooms, or the school district. In certain embodiments, where the lead was generated for an unregistered buyer, the lead further includes a means for inviting the buyer to register with Applicant's network 100, whereupon the buyer will be added to the inviting professional member's buyer network. Such a means may be, by way of example, a link which allows the professional member to send an email or text message invitation to the unregistered member.

In certain embodiments leads are provided to a member professional on that member's home page when they are logged into Network 100. In other embodiments, the member professional is notified of a lead by email and/or text message.

Score card module 312 provides each professional member with a buyer activity report showing an overview of the activity of buyers they own. Score card module 312 differs from the leads module 310 in that it includes information about a buyer's activity which does not rise to the level of a lead but may still be important information for the professional to have. By way of example and not limitation, where a lead is generated only when an unregistered buyer requests information on a property, a score card may display the activity of registered buyers on Network 100. Such information may include, without limitation, the amount the buyer has been pre-approved for, the price range of other property listings viewed, the mean or median value of the property listings viewed, the geographic area of other properties the buyer has viewed, or attributes of the property listings viewed, such as square footage, number of bedrooms, number of bathrooms, or the school district.

In certain embodiments, score card module 312 further includes a property activity report, which lists the number of times a property has been viewed online. In certain embodiments, buyers are able to text network 100 for information on a property listing. In such embodiments a property activity report also contains the number of times a property has been viewed via text message. In yet other embodiments a property activity report also provides a means for inviting unregistered buyers to the professional member's buyer network, such as a link to send an email or text message invitation. In other embodiments, each property report lists the registered buyers who have viewed each property.

In certain embodiments, score card module 312 further provides an invitation report listing those individuals the member professional has invited to join their network, either as another professional or as a buyer and whether the invitation has been accepted. In certain embodiments the invitation report also provides the date and time each invitation was sent. In certain embodiments the score card further provides a link or a button to resend an invitation.

In certain embodiments, professional network environment 300 further includes add listing module 314. As stated, in most embodiments, network 100 automatically obtains listings from the MLS and adds them to a member's listing module 308. However, in certain other embodiments add listing module 314 allows each professional member to add or delete the property listings that the professional member is associated with from listing module 308. In certain embodiments, only professional members that are identified as realtors have the ability to add or delete property listings from listing module 308. In such embodiments, the network environment for other types of professional members, i.e., title agents and loan officers, do not have add listing module 314. In certain embodiments, where a network environment does not include add listing module 314, it also does not include listing module 308.

Invite members module 316 allows each professional member to invite other professionals and buyers to join their network. In certain embodiments, invite members module 316 sends an invitation via email and/or text message. As will be explained further, upon accepting the invitation, the new member is added to either the inviting member's buyer network or professional network, depending on the new member's status.

Assign professional team module 318 allows each professional member to assign a team to each buyer in their network. Typically a professional team comprises a realtor, a loan officer, and a title agent. In certain embodiments however a team may include more than one realtor, loan officer, or title agent where the complexities of the transaction make it reasonable to do so. Further, typically the team will include the professional member who is making the assignment. However, in certain embodiments the professional member may not be included as a team member.

In certain embodiments the default professional team assigned to a buyer comprises the primary partners of the owning professional member. In such embodiments a professional member then uses the assign professional team module 318 to assign any additional team members necessary or, in certain embodiments, override the assignment of one or more primary partners.

Where a professional team has been assigned to a buyer, the contact information for those team members is presented to the buyer as part of a branded webpage when the buyer is using network 100. In certain embodiments the branded webpage further comprises photographs of the team members and/or any trademarks or logos associated with them. In certain embodiments, the branding is only of the owning professional member. Where the buyer's team members or owning professional change, the branding presented to the buyer as part of the webpage also automatically changes. This may occur where the owning professional changes the members of the professional team assigned to the buyer. This may further occur where, for example, the owning professional changes, such as may occur with enterprise teams, as described below. By way of example, if a buyer is owned by Professional A, Professional A's branding is displayed to the buyer. This may include Professional A's photo and contact information on a side bar or at the top of the webpage and may further include any trademarks or logos associated with Professional A. If buyer is reassigned to Professional B, the buyer's network environment 400 would automatically be rebranded to Professional B's branding.

Suggest listings module 320 allows a professional member to suggest a property listing to a buyer they own. The professional member may do this based on the individual buyer's activity report or any other criteria that is relevant. In certain embodiments the recommendation may be for a listing associated with the professional member, but in other embodiments the listing may not be. In certain embodiments the suggestion is sent to the buyer via email or text message. In yet other embodiments the suggestion is displayed to the buyer on their branded webpage when they are using network 100.

Turning to FIG. 3B, an alternate professional network is shown as enterprise network environment 350. Much like professional network environment 300, enterprise network environment 350 comprises one or more of modules 302-320. However, enterprise network environment 350 is specifically configured to accommodate teaming among professionals, and particularly among those who are formally associated, such as employees of the same company. As such, professional network environment further includes enterprise team module 322 which includes all the members who are going to share the single account. In such embodiments, the account may be managed by one or more of the enterprise team members or by one or more separate account manager. As the leads are added to leads module 310, the account manager assigns a professional team to the lead using module 318, where the professional team includes at least one member of enterprise team module 322. In other embodiments, the account manager simply assigns a member of enterprise team module 322, where that member is associated with a set of primary partners. The enterprise team member and his or her primary partners then become the professional team for the buyer associated with the lead. In such a way, enterprise network environment 350 allows for a broader scope of teaming for large, and even multi-state, organizations, allowing an account manager to assign out leads and teams over a vast area and to many different professionals based on location, availability, work load, seniority, or any other relevant criteria.

Turning to FIG. 4, the buyer network environment 400 is similar to the professional network environment 300 but is presented to those members (or teams of members) registered as buyers on network 100. As can be seen in FIG. 4, the buyer network environment 400 comprises professional team module 402, favorites listing module 404, personal account information module 406, and suggested listings module 408. In certain embodiments, buyer network environment 400 further comprises one or more of search listings module 410, invite members module 412, place offer module 414, map of properties module 416, pre-approval module 418, and calculators 420.

Professional team module 402 comprises a listing of the professional members assigned to each buyer. As discussed previously, typically this will include the professional member who owns the buyer and their primary partners and will comprise one realtor, one title agent, and one loan officer. However, in certain embodiments the professional member may use the assign professional team module 318 to either add additional team members from their professional network or to replace one or more of their primary partners or themselves on the team. Each buyer's professional team is displayed to them via a branded webpage as they are using network 100. In certain embodiments this includes the contact information and/or photograph of each of their professional team members. In certain embodiments, this also includes a link for contacting their professional team members such as, and without limitation, via email or text.

In certain embodiments, the buyer's activity and any leads generated therefrom is reported to their professional team. In other embodiments, the buyer's activity and leads are reported only to their owning professional member.

Favorites listing module 404 comprises a listing of each buyer's favorite property listings. In certain embodiments a buyer actively adds property listings to their favorites list by clicking on a link or button provided on the web page for each property listing. In other embodiments property listings are automatically added to a buyer's favorite listing upon viewing the property. In certain embodiments, a buyer's favorites listing may be ordered based on the date viewed, frequency viewed, length of time viewed, or other relative criteria.

Personal account information module 406 comprises each buyer's personal information. In certain embodiments, the personal information includes one or more of the buyer's name, address, telephone number, email address, login ID, password, pre-approval amount, or any other relevant information. In certain embodiments buyers have the ability to update or change their personal information.

Suggested listings module 408 comprises a listing for each buyer of properties suggested by their owning professional member. In certain embodiments the listing further includes properties suggested by other members of their professional team. In yet other embodiments the listing contains properties suggested based on the buyer's search criteria. In certain such embodiments the search criteria is actively designated by the buyer. In other such embodiments the search criteria determined by network 100 is based on properties viewed by the buyer.

Search listings module 410 allows the buyer to search all property listings in listing database 102 (FIG. 1). As stated, in certain embodiments the property listings include a link or button to add the listing to the buyer's favorites list. In certain embodiments, search listings module 410 allows a buyer to search on listings that are nearby to the buyer's physical location. In such embodiments, when a buyer texts network 100 using a mobile phone and requests information on nearby properties, network 100 uses geocoding to search for and provide search results that are determined by the buyer's present location. As will be appreciated, geocoding is the process of finding associated geographic coordinates from other geographic data. Further, in certain such embodiments, additional search criteria may be provided by the buyer to narrow the search results, such as and without limitation price or size. The results of the search are provided in a list format and may or may not be included in a map. In alternate embodiments, rather than requesting information on properties near the buyer's present location, the buyer may request information on properties near another listing or physical location.

Invite members module 412 is similar to invite members module 316 (FIG. 3A) but is presented in the buyer network environment 400 and is used by the member buyer to invite new buyers to network 100. When such an invitation is accepted, the new buyer is assigned to the same professional member who owns the inviting buyer. In certain embodiments, the default professional team assigned to such a new buyer is the same team as the inviting buyer's. In certain embodiments invitations are sent by module 412 via email or text message.

In certain embodiments buyer network environment 400 further comprises place offer module 414, which allows member buyers to alert the realtor on their professional team that they would like to place an offer on a specific property listing. In certain embodiments an alert is further sent to the other members of the buyer's professional team. In certain embodiments the alert is sent via email or text message. In certain embodiments, place offer module 414 further allows the buyer to make an offer on a specific property listing.

Map module 416 provides a map to each buyer indicating the location of various properties for sale. In certain embodiments, the maps indicate the location of properties the buyer has marked as a favorite, that the buyer has viewed, or that meets a search criteria provided by the buyer.

In certain embodiments buyer network environment 400 further comprises pre-approval module 414. In certain embodiments, pre-approval module 414 allows the buyer to get pre-approved by a lender for a mortgage of a certain amount. In certain embodiments, the pre-approval process includes notifying the loan officer on the buyer's professional team, wherein the buyer is pre-approved through the loan officer's lending institution.

Finally, calculators module 420 comprises mortgage calculators to assist buyers in determining what their estimated monthly payment would be based on the amount of their loan and interest rate. In certain embodiments the calculated mortgage further includes an estimation of taxes and/or insurance costs.

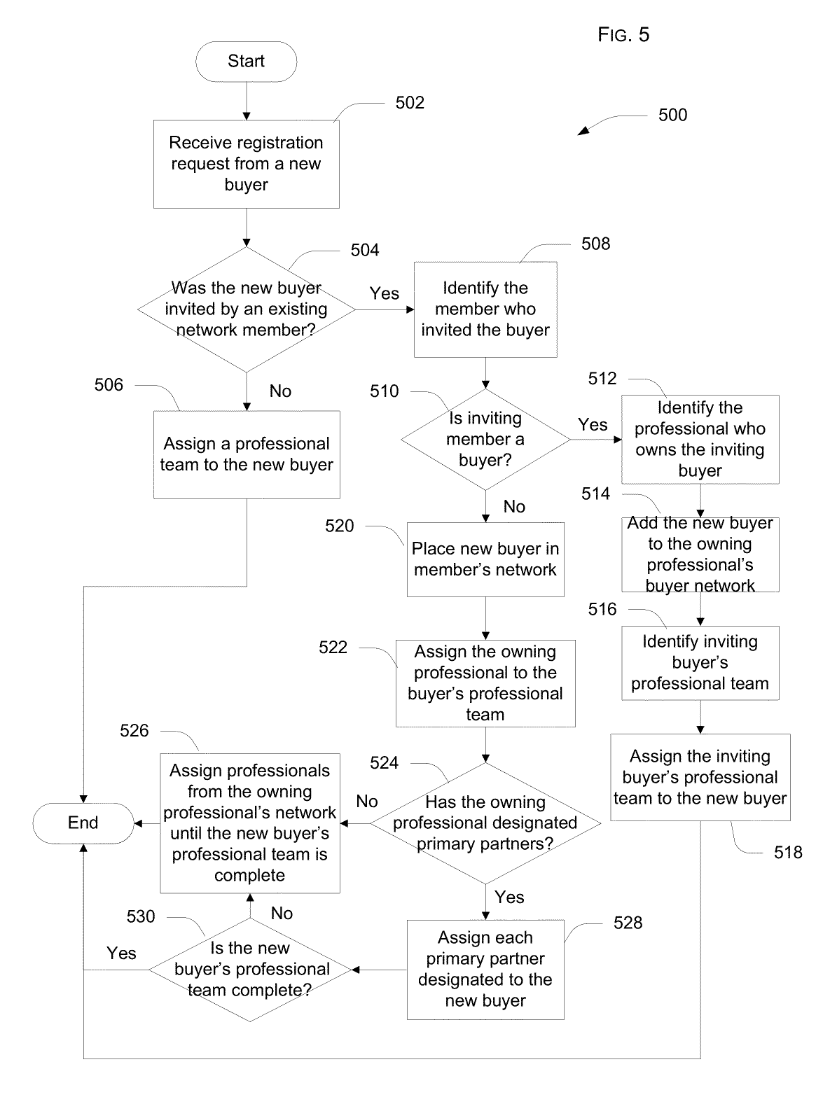

Exemplary flowcharts detailing how key aspects of Applicant's network 100 operate are provided in FIGS. 5, 6, and 7. As can be seen in FIG. 5, method 500 indicates how a new buyer is added to network 100 and assigned a professional team. Upon receiving a registration request from a new buyer, a determination is made whether the buyer was invited by an existing network member, as indicated by blocks 502 and 504. In certain embodiments a new member indicates whether they were invited to the system and who they were invited by. In other embodiments, the inviting member sends the invitee a link or code to use which indicates that they were invited and who they were invited by.

If the new buyer was not invited to the network by an existing member, then they are assigned a professional comprising a realtor, a title agent, and a loan officer, as indicated by block 506. In some embodiments this assignment is made randomly but in others it is based on one or more criteria, including, for example, the geographic location of the buyer, the geographic location of the area the buyer is looking to purchase property, and the type of property the buyer wants to purchase.

If the new buyer was invited by an existing member, the inviting member is identified as indicated by block 508. As stated, in certain embodiments, the new buyer indicates the member who invited them, but in other embodiments, the inviting member sends the invitee a link or code to use which indicates who invited them to network 100.

If the inviting member is another buyer, the professional who owns the inviting buyer is identified and the new buyer is assigned to that professional's buyer network, as indicated by blocks 510, 512, and 514. Both the new buyer and inviting buyer are now referred to as being “owned” by the same professional member. The professional team assigned to the inviting buyer is then identified and assigned to the new buyer, as indicated by blocks 516 and 518.

However, as indicated by blocks 510 and 520, if the inviting member was a professional member of network 100, the new buyer is added to that professional member's buyer network and is referred to as being “owned” by that professional member. The owning professional member is then assigned to the buyer as one of the buyer's professional team members, as indicated by block 522. If the owning professional member has designated one or more primary partners, these individuals are also assigned to the new buyer as part of his or her professional team, as indicated by blocks 524 and 528. If the buyer's professional team is not complete, due to the owning professional member having designated less than two primary members (such that a complete team, including the inviting professional member, includes one realtor, one loan officer, and one title agent) or if the owning professional member has not designated primary partners, the new buyer is assigned team members from the owning professional member's network until the new buyer's professional team is complete, as indicated by blocks 526 and 530.

While not indicated as part of method 500, as described above, in certain embodiments, the owning professional member can replace one or more of the professionals assigned to a new buyer according to process 500 with other professional members in their network by using assign professional team module 318.

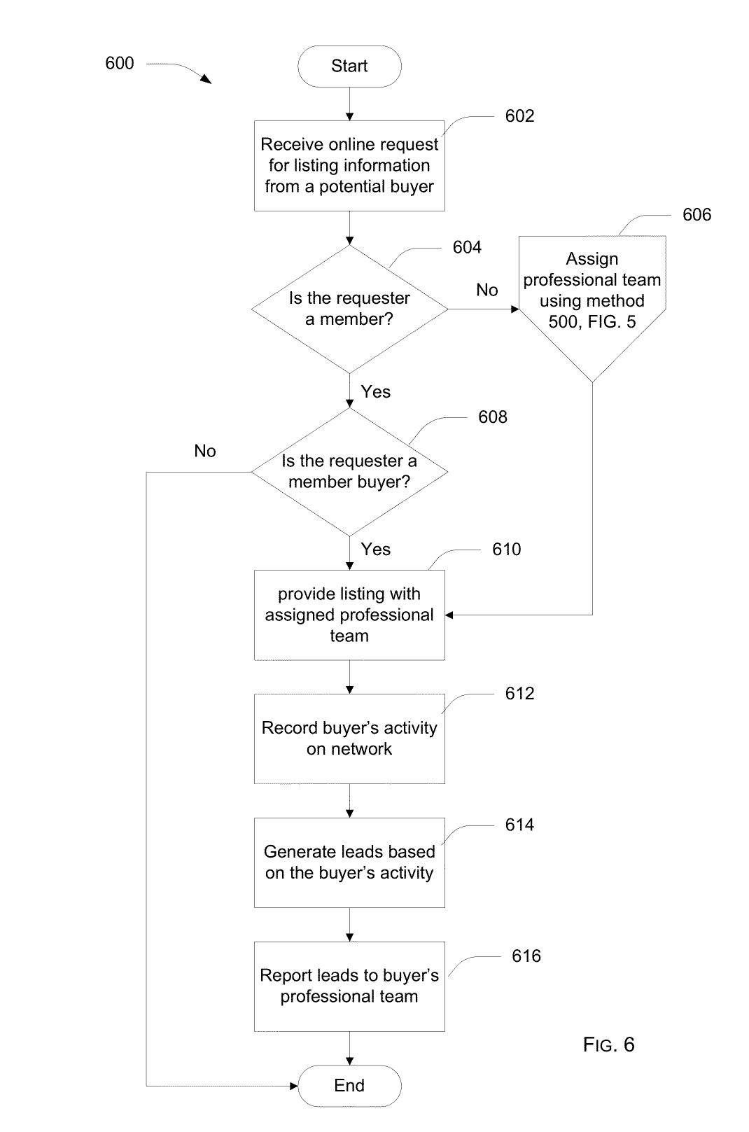

Turning now to FIG. 6, method 600 indicates how leads are generated through online activity and reported to professional members. As indicated by method 600, when a request is first received online for listing information, a determination is made as to whether the requester is a member, as indicated by blocks 602 and 604. In certain embodiments this can be determined by verifying whether the requester is logged into network 100. In certain embodiments only members can view listing information, which may include the property's MLS listing.

As indicated by block 606, in certain embodiments, when the requester is not a member, the requester is asked to register with network 100 as a new buyer using method 500 illustrated in FIG. 5. However, when the requester is a member buyer the listing information is provided along with the member buyer's professional team, as indicated by blocks 604, 608, and 610. In certain embodiments, this is done as a branded webpage and includes one or more of the contact information and picture of each professional team member. In certain embodiments the contact information provided is a link which enables the member buyer to send a message to one or more of their professional team members through network 100.

As indicated by block 612, the buyer's request for listing information is recorded in activity database 106 (FIG. 1). In certain embodiments, additional actions taken by the buyer are also recorded, such as the number of times the buyer has looked at a listing, the length of time a buyer has looked at a listing, whether the buyer has forwarded the listing, search criteria used by the buyer, or the like.

The buyer's activity information is then used to generate leads, as indicated by block 614. In certain embodiments, a lead is generated only when the buyer's activity meets specific criteria such as, and without limitation, the buyer is an unregistered user, the buyer has viewed the property listing a certain number of times, the buyer has added the property to their favorites list, the buyer has forwarded the property listing, or any other relevant criteria. In certain embodiments, the leads are then sent to the buyer's professional team, as indicated by block 616. In other embodiments, the lead is only sent to the owning professional member.

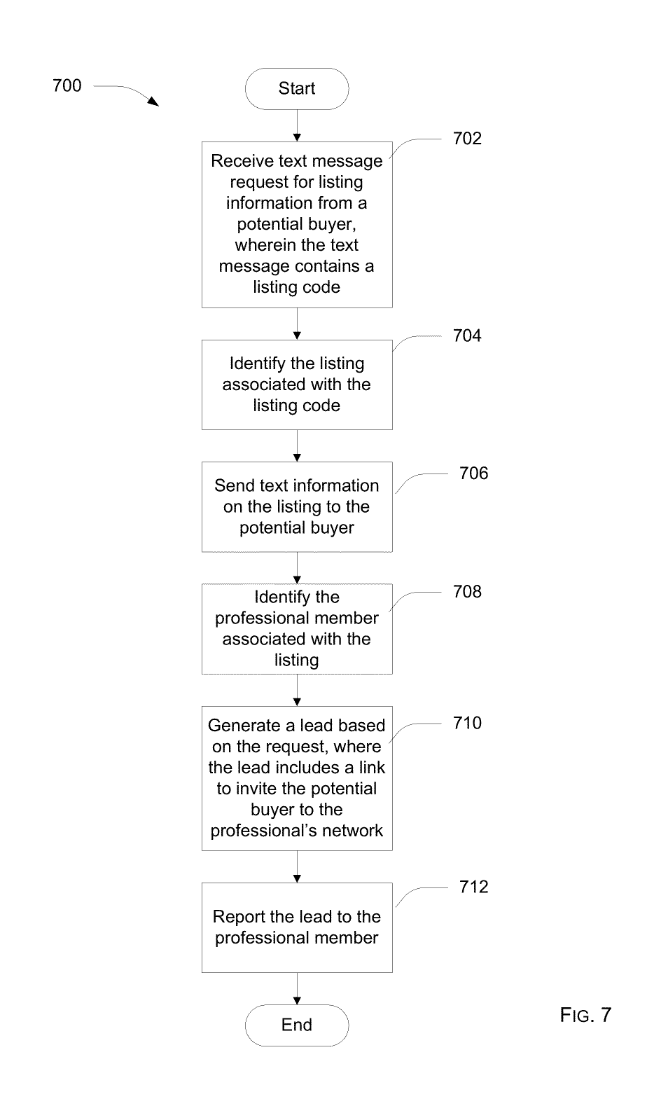

Turning now to FIG. 7 an alternative method of generating a lead when a request for information is received via text message from a mobile phone is presented. In certain embodiments of Applicant's network 100, as part of their membership, professional members, and in particular those that are identified as realtors, are provided with sign riders. As will be appreciated, sign riders are signs that generally hang below or above the real estate listing sign placed in front of available property. In the present embodiments, Applicant's sign riders contain a call to action for buyers to send a text message to a specific code, wherein the code includes a market code and a property number for the property the buyer is seeking information on. In certain embodiments, the code further comprises an agent code that identifies the agent listing the property. As can be seen in method 700, when such a text message is received by Applicant's network 100, the property listing associated with the code included in the text message is identified, as indicated by blocks 702 and 704. Network 100 then sends a returning text message comprising basic information about the listing, including one or more of the asking price, square footage, number of bedrooms, and number of bathrooms, as indicated by block 706. In certain embodiments the listing agents' contact information is further included.

The professional member associated with the listing is then identified by network 100 and a lead is generated, where the lead includes a link to send the requester a text message invitation to join the professional member's buyer network, as indicated by blocks 708 and 710. In certain embodiments, the lead further includes the telephone number of the requester and/or an identification of the property listing the requester was seeking information on. Once the lead is generated, the lead is reported to the professional member via email and/or text message, as indicated by block 712.

In certain embodiments, individual blocks of methods 500, 600, or 700 described above may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the blocks 504-530 recited in FIG. 5, the blocks 602-616 recited in FIG. 6, or the blocks 702-712 recited in FIG. 7.

In yet other embodiments, the invention includes instructions residing in any other computer program product, where those instructions are executed by a computer external to, or internal to, a computing system to perform one or more of the blocks 504-530 recited in FIG. 5, the blocks 602-616 recited in FIG. 6, or the blocks 702-712 recited in FIG. 7. In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

While the preferred embodiments of the present invention have been illustrated in detail, it should be apparent that modifications and adaptations to those embodiments may occur to one skilled in the art without departing from the scope of the present invention.

What is claimed is:

1. A network, comprising:
a server comprising a processor, a non-transitory computer readable medium in communication with the processor, and computer readable program code encoded in the computer readable medium;
a plurality of professional member profiles and a plurality of nonprofessional user profiles encoded in the computer readable medium, wherein each of the plurality of professional member profiles is associated with a professional member of the network, wherein each of the plurality of nonprofessional user profiles is associated with a nonprofessional user of the network and is assigned to a professional member;
an activity database encoded in the computer readable medium comprising a plurality of records each corresponding to activity of one of the plurality of nonprofessional users on the network;
wherein the computer readable program code comprises computer readable program steps that, when executed by the processor, generate a lead based on one of the plurality of records.

2. The network of claim 1, wherein the computer readable program code further comprises computer program steps that, when executed by the processor, notifies the assigned professional member of the nonprofessional user associated with the one of the plurality of records the lead is based on.

3. The network of claim 2, wherein the computer readable program code further comprises computer program steps that, when executed by the processor, notifies the assigned nonprofessional member via text message.

4. The network of claim 2, further comprising a partner database encoded in the computer readable medium comprising an association of each professional member of the network with at least one partner, wherein the partner is another professional member of the network, wherein the computer readable program code further comprises computer readable program steps that, when executed by the processor, notifies the at least one partner of the assigned professional member of the lead.

5. The network of claim 1, further comprising a listing database encoded in the computer readable medium comprising a plurality of listings, wherein the lead comprises:
contact information for the nonprofessional user associated with the one of the plurality of records the lead is based upon; and
identification of at least one of the plurality of listings.

6. The network of claim 5, wherein the computer readable program code further comprises computer readable program steps that, when executed by the processor, receive a request from a nonprofessional user for information associated with one of the plurality of listings.

7. The network of claim 6, wherein the computer readable program code further comprises computer readable program steps that, when executed by the processor:
determine whether one of the plurality of nonprofessional user profiles is associated with the nonprofessional user who made said request; and
when none of the plurality of nonprofessional user profiles is associated with the nonprofessional user, transmit an invitation for the nonprofessional user to create a nonprofessional user profile.

8. The network of claim 7, wherein the request comprises an identifier identifying a professional member, wherein the computer readable program code further comprises computer readable program steps that when executed by the processor:
generate a nonprofessional user profile associated with the nonprofessional user who made the request; and
assign the nonprofessional user profile to the professional member identified by the first identifier.

9. The network of claim 6, wherein the computer readable program code further comprises computer readable program steps that, when executed by the processor:
generate a record corresponding to the request; and
store the record in the activity database.

10. The network of claim 6, wherein the request comprises an identifier identifying one of the plurality of listings, wherein the computer readable program code further comprises computer readable program steps that, when executed by the processor, transmit information associated with the one of the plurality of listings identified by the identifier to the nonprofessional user who made said request.

11. The network of claim 10, wherein the computer readable program code further comprises computer readable program steps that, when executed by the processor:
receive said request via text message; and
transmit said information via text message.

12. The network of claim 1, further comprising a threshold encoded in the computer readable medium, wherein the computer readable program code further comprises computer readable program steps that when executed by the processor:
compare each record of the plurality of records with the threshold; and
generate the lead when the threshold is met.

13. A computer program product encoded in a computer readable medium and useable with a programmable computer processor to generate a lead for one of a plurality of professional members of a network, wherein the network is used by a plurality of nonprofessional users, wherein each of the plurality of nonprofessional users are assigned to one of the plurality of professional members, the computer program product comprising:
computer readable program code which causes said programmable processor to generate a lead based on activity of one of the plurality of nonprofessional users on the network; and
computer readable program code which causes said programmable processor to notify the professional member assigned to the one of the plurality of nonprofessional users whose activity the lead is based on.

14. The computer readable program product of claim 13, further comprising computer readable program code which causes said programmable processor to notify the professional member via text message.

15. The computer readable program product of claim 13, wherein each of the plurality of professional members is associated with at least one partner, wherein the partner is another professional member of the network, the computer readable program product further comprising computer readable program code which causes said programmable processor to notify the at least one partner of the assigned professional member of the lead.

16. The computer readable program product of claim 13, wherein the network comprises a plurality of listings, the computer readable program product further comprising computer readable program code which causes said programmable processor to generate a lead comprising:
contact information for the one of the plurality of nonprofessional users whose activity the lead is based on; and
identification of at least one of the plurality of listings.

17. The computer readable program product of claim 16, further comprising computer readable program code which causes said programmable processor to receive a request from one of the plurality of nonprofessional users for information associated with one of the plurality of listings.

18. The computer readable program product of claim 17, further comprising:
computer readable program code which causes said programmable processor to determine whether the one of the nonprofessional users who made said request is assigned to one of the plurality of professional members; and
computer readable program code which, when the one of the nonprofessional users who made said request is not assigned to one of the plurality of professional members, causes said programmable processor to transmit an invitation for the nonprofessional user to register with the network.

19. The computer readable program product of claim 18, wherein the request comprises an identifier identifying one of the plurality of professional members, the computer readable program product further comprising: computer readable program code which causes said programmable processor to assign the nonprofessional user to the one of the plurality of professional members identified by the first identifier.

20. The computer readable program product of claim 17, further comprising: computer readable program code which causes said programmable processor to generate said lead based on the request.

21. The computer readable program product of claim 17, wherein the request further comprises an identifier identifying one of the plurality of listings, further comprising computer readable program code which causes said programmable processor to transmit information associated with the one of the plurality of listings identified by the second identifier to the nonprofessional user who made said request.

22. The computer readable program product of claim 21, further comprising:
computer readable program code which causes said programmable processor to receive said request via text message; and
computer readable program code which causes said programmable processor to transmit said information via text message.

23. The computer readable program product of claim 13, further comprising:
computer readable program code which causes said programmable processor to compare each record of the plurality of records with the threshold; and
computer readable program code which causes said programmable processor to generate the lead when the threshold is met.
